(19) United States
(12) Patent Application Publication
(10) Pub. No.: US 2026/0164137 A1
(43) Pub. Date: Jun. 11, 2026

(54) IMAGING DEVICE

(71) Applicant: ARASHI VISION INC., Shenzhen (CN)

(72) Inventors: Kun TAN, Shenzhen (CN); Jundi XIE, Shenzhen (CN); Changhua LIN, Shenzhen (CN)

(73) Assignee: ARASHI VISION INC., Shenzhen (CN)

(21) Appl. No.: 19/180,027

(22) Filed: Apr. 15, 2025

(30) Foreign Application Priority Data
Apr. 16, 2024 (CN) 202410457945.X

(51) Int. Cl. H04N 23/76; H04N 23/698; H04N 23/71; H04N 23/73

(52) U.S. Cl. CPC H04N 23/76; H04N 23/698; H04N 23/71; H04N 23/73

(57) ABSTRACT

The present disclosure relates to an imaging device including a first imaging assembly, a second imaging assembly, and a processing assembly, with the view-finding regions of the first imaging assembly and the second imaging assembly partially overlapping. The processing assembly is configured to generate a third image based on the first image and the second image. The brightness of the transition region in the third image can be substantially the same or change substantially linearly.

### CROSS-REFERENCE TO RELATED APPLICATION

The present disclosure claims the benefit of priority to Chinese Patent Application No. 202410457945.X, filed on Apr. 16, 2024, the entire content of which is hereby incorporated by reference in its entirety.

### BACKGROUND

The present disclosure relates to the field of image processing, specifically, to an imaging device.

In recent years, with the rapid development of image exposure technology and the continuous iteration of imaging devices, imaging devices with multiple lenses and panoramic shooting capabilities have been widely used. These imaging devices can generate panoramic images with a wide field of view by splicing original images captured by multiple lenses.

However, when using imaging devices with related technology to capture panoramic images, there exist color difference and brightness difference problems between original images captured by different lenses using the same exposure parameters. This limits the exposure effect of each lens, resulting in poor imaging quality, low dynamic range, and poor user experience.

### SUMMARY

To overcome the problems in related technologies, the present disclosure provides an imaging device.

The present disclosure provides an imaging device, which includes:
a first imaging assembly, configured to capture a first image;
a second imaging assembly, configured to capture a second image, with the view-finding regions of the first imaging assembly and the second imaging assembly partially overlapping; and
a processing assembly, connected to the first imaging assembly and the second imaging assembly, configured to generate a third image based on the first image and the second image,
where the third image is a spliced image, including a transition region from a first image region to a second image region, with the brightness of the transition region being substantially the same or changing substantially linearly; and where the image content of the first image region is at least a part of the image content of the first image, and the image content of the second image region is at least a part of the image content of the second image.

In some implementations of the present disclosure, in the transition region, along a vertical direction of a splicing direction, the brightness difference between any two of the brightness of the overlapped region, the brightness of the first non-overlapped region, and the brightness of the second non-overlapped region is less than the brightness difference threshold.

The image content of the first non-overlapped region is at least a part of the non-overlapped image content of the first image.

The image content of the second non-overlapped region is at least a part of the non-overlapped image content of the second image.

The image content of the overlapped region is at least a part of the overlapped image content between the first image and the second image.

In some implementations of the present disclosure, the processing assembly is further configured to:
control the first imaging assembly to capture the first image based on ambient brightness information corresponding to the view-finding region of the first imaging assembly, ensuring that the brightness of the first image region in the generated third image is adapted to the ambient brightness of the view-finding region of the first imaging assembly; and
control the second imaging assembly to capture the second image based on ambient brightness information corresponding to the view-finding region of the second imaging assembly, ensuring that the brightness of the second image region in the generated third image is adapted to the ambient brightness of the view-finding region of the second imaging assembly.

In some implementations of the present disclosure, when capturing the first image and the second image, the first imaging assembly and the second imaging assembly use independent exposure strategies for exposure control.

In some implementations of the present disclosure, generating the third image based on the first image and the second image includes:
performing brightness adjustment processing on the first image and the second image, respectively, to obtain a fourth image corresponding to the first image and a fifth image corresponding to the second image; and
performing image splicing processing on the fourth image and the fifth image to obtain the third image.

In some implementations of the present disclosure, performing brightness adjustment processing on the first image and the second image, respectively, to obtain a fourth image corresponding to the first image and a fifth image corresponding to the second image includes:
determining the first gain adjustment information of the first image and the second gain adjustment information of the second image based on the first exposure parameters corresponding to the first image and the second exposure parameters corresponding to the second image, where the first exposure parameters are the exposure parameters when the first imaging assembly captures the first image, and the second exposure parameters are the exposure parameters when the second imaging assembly captures the second image; and
performing brightness adjustment processing on the first image based on the first gain adjustment information to obtain the fourth image, and performing brightness adjustment processing on the second image based on the second gain adjustment information to obtain the fifth image.

In some implementations of the present disclosure, determining the first gain adjustment information of the first image and the second gain adjustment information of the second image based on the first exposure parameters and the second exposure parameters includes:
determining the first exposure difference information corresponding to the first image and the second exposure difference information corresponding to the second image based on the first exposure parameters and the second exposure parameters; and
determining the first gain adjustment information based on the first exposure difference information, and determining the second gain adjustment information based on the second exposure difference information.

In some implementations of the present disclosure, the first gain adjustment information includes a first gain table, the range of which corresponds to the first image, and the first gain table includes multiple first sub-regions, each having a corresponding first gain value; and
the second gain adjustment information includes a second gain table, the range of which corresponds to the second image, and the second gain table includes multiple second sub-regions, each having a corresponding second gain value.

In some implementations of the present disclosure, determining the first gain adjustment information based on the first exposure difference information includes:
determining a first preset region of the first image, corresponding to at least part of the first sub-regions, and corresponding to the first exposure difference information; and
determining the first gain value of each first sub-region corresponding to the first preset region based on the first exposure difference information to obtain the first gain table.

Determining the second gain adjustment information based on the second exposure difference information includes:
determining a second preset region of the second image, corresponding to at least part of the second sub-regions, and corresponding to the second exposure difference information; and
determining the second gain value of each second sub-region corresponding to the second preset region based on the second exposure difference information to obtain the second gain table.

In some implementations of the present disclosure, determining the first preset region of the first image includes:
performing region division on the first image based on the view-finding regions of the first image and the second image to obtain the first preset region.

Determining the second preset region of the second image includes:
performing region division on the second image based on the view-finding regions of the second image and the first image to obtain the second preset region.

In some implementations of the present disclosure, the intersection of the first preset region and the second preset region in the third image corresponds to the transition region.

In some implementations of the present disclosure, the first image further includes a third preset region, located at the center of the first image, with each first sub-region corresponding to the third preset region having a corresponding first preset gain value.

The second image further includes a fourth preset region, located at the center of the second image, with each second sub-region corresponding to the fourth preset region having a corresponding second preset gain value.

In some implementations of the present disclosure, determining the first gain value of each first sub-region corresponding to the first preset region based on the first exposure difference information includes:
determining a part of the first sub-regions corresponding to the first preset region as the first target sub-region, and determining another part of the first sub-regions corresponding to the first preset region as the second target sub-region, where the first target sub-region is set farther from the third preset region compared to the second target sub-region;
determining the gain value of each first target sub-region based on the first exposure difference information; and
determining the gain value of each second target sub-region based on the gain values of the first target sub-regions, the first preset gain value, and the positions of the second target sub-regions.

Determining the second gain value of each second sub-region corresponding to the second preset region based on the second exposure difference information includes:
determining a part of the second sub-regions corresponding to the second preset region as the third target sub-region, and determining another part of the second sub-regions corresponding to the second preset region as the fourth target sub-region, where the third target sub-region is set farther from the fourth preset region compared to the fourth target sub-region;
determining the gain value of each third target sub-region based on the second exposure difference information; and
determining the gain value of each fourth target sub-region based on the gain values of the third target sub-regions, the second preset gain value, and the positions of the fourth target sub-regions.

In some implementations of the present disclosure, determining the first gain value of each first sub-region corresponding to the first preset region based on the first exposure difference information includes:
determining the first brightness difference information corresponding to the first exposure difference information;
determining the first ratio value corresponding to the first brightness difference information; and
determining the first gain value of each first sub-region based on the first ratio value.

Determining the second gain value of each second sub-region corresponding to the second preset region based on the second exposure difference information includes:
determining the second brightness difference information corresponding to the second exposure difference information;
determining the second ratio value corresponding to the second brightness difference information; and
determining the second gain value of each second sub-region based on the second ratio value.

Alternatively, determining the first gain value of each first sub-region corresponding to the first preset region based on the first exposure difference information includes:
determining the first brightness difference information corresponding to the first exposure difference information; and
determining the first gain value of each first sub-region based on the first brightness difference information.

Determining the second gain value of each second sub-region corresponding to the second preset region based on the second exposure difference information includes:
determining the second brightness difference information corresponding to the second exposure difference information; and
determining the second gain value of each second sub-region based on the second brightness difference information.

In some implementations of the present disclosure, determining the first brightness difference information corresponding to the first exposure difference information includes:
determining the first brightness difference information corresponding to the first exposure difference information based on the first exposure difference information and the first preset configuration information, where the first preset configuration information is used to characterize the correspondence relationship between the exposure difference information and the brightness difference information.

Determining the second brightness difference information corresponding to the second exposure difference information includes:
determining the second brightness difference information corresponding to the second exposure difference information based on the second exposure difference information and the first preset configuration information; and/or
determining the first ratio value corresponding to the first brightness difference information includes:
determining the first ratio value corresponding to the first brightness difference information based on the first brightness difference information and the second preset configuration information, where the second preset configuration information is used to characterize the correspondence relationship between the brightness difference information and the ratio value.

Determining the second ratio value corresponding to the second brightness difference information includes:
determining the second ratio value corresponding to the second brightness difference information based on the second brightness difference information and the second preset configuration information.

In some implementations of the present disclosure, performing brightness adjustment processing on the first image based on the first gain adjustment information to obtain the fourth image includes:
multiplying the pixel value of each pixel of the first image by the first gain value of each pixel corresponding to the first sub-region in the first gain table, to obtain the first target pixel value of each pixel, thereby obtaining the fourth image.

Performing brightness adjustment processing on the second image based on the second gain adjustment information to obtain the fifth image includes:
multiplying the pixel value of each pixel of the second image by the second gain value of each pixel corresponding to the second sub-region in the second gain table, to obtain the second target pixel value of each pixel, thereby obtaining the fifth image.

In some implementations of the present disclosure, the processing assembly is further configured to:
perform video synthesis on the plurality of third images within a preset time to obtain a target video.

In some implementations of the present disclosure, the processing assembly includes an image signal processing unit, which is used to perform brightness adjustment processing on the first image based on the first gain adjustment information to obtain the fourth image and perform brightness adjustment processing on the second image based on the second gain adjustment information to obtain the fifth image.

In some implementations of the present disclosure, the processing assembly includes a shooting control unit, which is used to determine the first gain adjustment information of the first image and the second gain adjustment information of the second image based on the first exposure parameters corresponding to the first image and the second exposure parameters corresponding to the second image; and/or, the shooting control unit is used to perform image splicing processing on the fourth image and the fifth image to obtain the third image.

In some implementations of the present disclosure, the imaging device further includes a housing, where the image sensor of the first imaging assembly, the image sensor of the second imaging assembly, and the processing assembly are all disposed inside the housing.

The technical solutions provided by the implementations of the present disclosure can include the following beneficial effects: by capturing the first image and the second image through the first imaging assembly and the second imaging assembly of the imaging device, respectively, and generating the third image based on the first image and the second image through the processing assembly of the imaging device, where the brightness of the transition region in the third image can be substantially the same or change substantially linearly along the vertical direction of the splicing direction. On the basis of ensuring independent exposure effects of each imaging assembly, the brightness difference in the transition region is reduced when generating the third image, ensuring that the third image has good imaging quality, high dynamic range, and low brightness difference, thereby enhancing user experience.

It should be understood that the above general description and the detailed description below are merely exemplary and explanatory and are not restrictive to the present disclosure.

### BRIEF DESCRIPTION OF DRAWINGS

The accompanying drawings, which are incorporated in and constitute a part of this specification, illustrate implementations of the present disclosure and, together with the description, serve to explain the principles of the present disclosure.

FIG. 1 is a block diagram of an imaging device, according to some implementations of the present disclosure.

FIG. 2 is a schematic diagram of a first image, according to some implementations of the present disclosure.

FIG. 3 is a schematic diagram of a second image, according to some implementations of the present disclosure.

FIG. 4 is a schematic diagram illustrating the correspondence between a third image and the first image and the second image, according to some implementations of the present disclosure.

FIG. 5 is a schematic diagram of a third image, according to some implementations of the present disclosure.

FIG. 6 is another schematic diagram of a third image, according to some implementations of the present disclosure.

FIG. 7 is still another schematic diagram of a third image, according to some implementations of the present disclosure.

FIG. 8 is another schematic diagram of a first image, according to some implementations of the present disclosure.

FIG. 9 is another schematic diagram of a second image, according to some implementations of the present disclosure.

FIG. 10 is a schematic diagram of a first gain table, according to some implementations of the present disclosure.

FIG. 11 is a schematic diagram of a second gain table, according to some implementations of the present disclosure.

Some implementations of the present disclosure will be described with reference to the accompanying drawings.

### DETAILED DESCRIPTION

The present disclosure will be described in detail with reference to some implementations, which are illustrated in the accompanying drawings. In the following description, unless otherwise indicated, the same numbers in different drawings represent the same or similar elements. The implementations described in the following implementations do not represent all implementations consistent with the present disclosure. Rather, they are merely examples of devices and methods consistent with some aspects of the present disclosure as detailed in the appended claims.

In recent years, with the rapid development of image exposure technology and the continuous iteration of imaging devices, such as panoramic cameras and mobile phones with multiple lenses and panoramic shooting functions, these imaging devices have been widely used. In related technologies, imaging devices can capture original images through multiple lenses corresponding to different view-finding regions and use image splicing technology to splice multiple original images into a panoramic image with a wide field of view.

However, when using related technology imaging devices to capture panoramic images, there is often a significant brightness difference between the original images captured by different lenses. To address this issue, it is usually necessary to control multiple lenses of the imaging device to use a synchronized exposure strategy, i.e., the same exposure parameters for image acquisition. Each lens is affected by the ambient brightness of the view-finding region corresponding to other lenses, which prevents optimal exposure effects, resulting in poor imaging quality, low dynamic range, and poor user experience in the final panoramic image.

Based on this, some implementations of the present disclosure provide an imaging device that captures a first image and a second image through a first imaging assembly and a second imaging assembly of the imaging device, respectively. A processing assembly of the imaging device generates a third image based on the first image and the second image, allowing the brightness of the transition region in the third image to be substantially the same or change substantially linearly along the vertical direction of the splicing direction. This reduces the brightness difference in the transition region when generating the third image while ensuring independent exposure effects of each imaging assembly, resulting in a third image with good imaging quality, high dynamic range, and low brightness difference, thereby enhancing user experience.

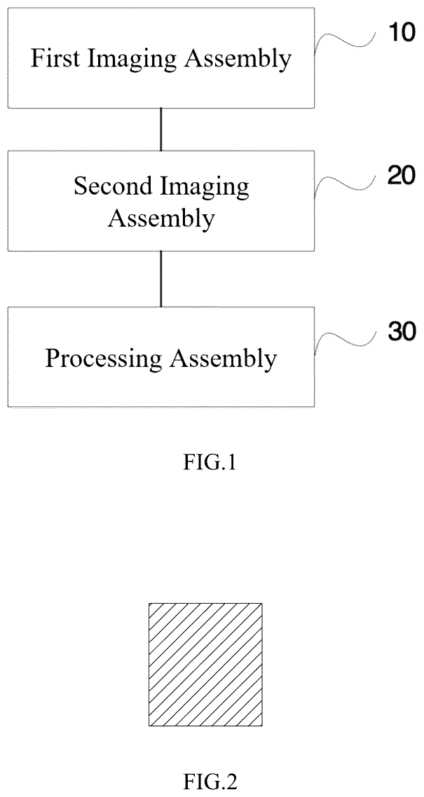

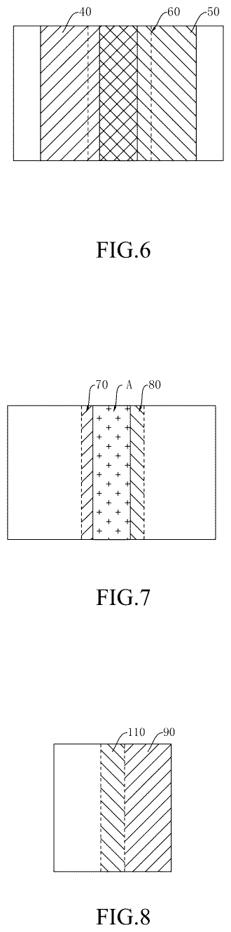

In an implementation, an imaging device is provided, which can be a terminal device with multiple imaging assemblies, such as a mobile phone or camera. As shown in FIG. 1, the imaging device includes a first imaging assembly 10, a second imaging assembly 20, and a third imaging assembly. The first imaging assembly 10 is configured to capture a first image, and the second imaging assembly 20 is configured to capture a second image. A part of the view-finding region of the first imaging assembly 10 overlaps with a part of the view-finding region of the second imaging assembly 20. A processing assembly 30 is connected with the first imaging assembly 10 and the second imaging assembly 20, and is configured to generate a third image based on the first image and the second image. As shown in FIG. 5 or FIG. 6, the third image is a spliced image, and it includes a transition region 60 from a first image region 40 to a second image region 50. Along the vertical direction of the splicing direction, the brightness of the transition region 60 is substantially the same or changes substantially linearly. The image content of the first image region 40 is at least a part of the image content of the first image, and the image content of the second image region 50 is at least a part of the image content of the second image.

The first imaging assembly 10 may include, for example, a first camera and an image sensor corresponding to the first camera, and the second imaging assembly 20 may include a second camera and an image sensor corresponding to the second camera. The first image and the second image can be captured respectively by the first imaging assembly 10 and the second imaging assembly 20, and the view-finding region of the first imaging assembly 10 overlaps with the view-finding region of the second imaging assembly 20. The overlapping view-finding region contains the same subject, resulting in overlapping image content between the first image and the second image.

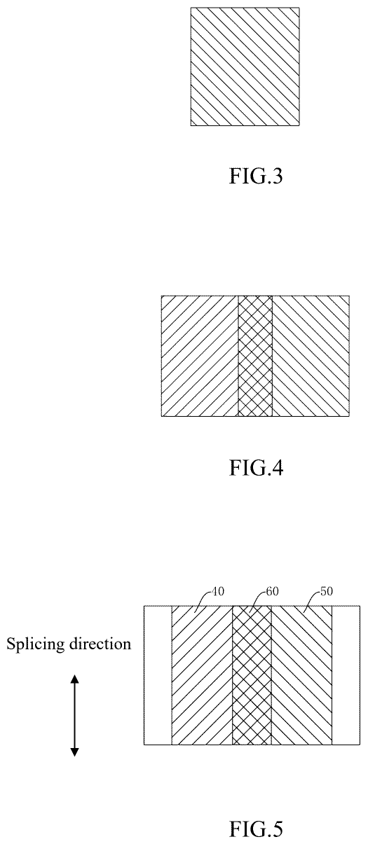

The processing assembly 30 can include an image signal processing unit (ISP), a microcontroller (MCU), a video processor (VPU), or other devices with information processing capabilities. The processing assembly 30 is connected with the first imaging assembly 10 and the second imaging assembly 20 and can receive the first image captured by the first imaging assembly 10 as shown in FIG. 2 and the second image captured by the second imaging assembly 20 as shown in FIG. 3, and generate a third image as shown in FIG. 4 based on the first image and the second image.

As shown in FIG. 5 and FIG. 6, the generated third image is a spliced image, including the first image region 40 and the second image region 50. The image content of the first image region in the third image is all or part of the image content of the first image, and the image content of the second image region 50 in the third image is all or part of the image content of the second image. The image content refers to the actual content presented by the image apart from the image brightness, ensuring that the first image region 40 and the second image region 50 correspond to at least part of the first image and at least part of the second image, respectively. When the first image region 40 and the second image region 50 correspond to parts of the first image and the second image, respectively, the image content of the first image region 40 and the second image region 50 must at least include the overlapping image content between the first image and the second image.

The transition region can refer to the part or the entire area located between the first image region and the second image region, where the brightness of the transition region is substantially the same or changes linearly, which can eliminate the color difference between the first image region and the second image region. For example, as shown in FIG. 5, the transition region 60 from the first image region 40 to the second image region 50 can be the overlapping region of the first image region 40 and the second image region 50. As shown in FIG. 6, the transition region 60 from the first image region 40 to the second image region 50 can also include the overlapping region of the first image region 40 and the second image region 50 as well as part of the non-overlapping area of the first image region 40 and the second image region 50. For example, the non-overlapping part of the first image region 40 (first non-overlapped region 70) can account for an area ratio of the first image region 40 less than a preset ratio, for example, a preset ratio of 1%, 2%, 3%, 4%, 5%, 6%, 7%, 8%, 9%, 10%, 20%, 30%. The non-overlapping part of the second image region 50 (second non-overlapped region 80) can account for an area ratio of the second image region 50 less than a preset ratio, for example, a preset ratio of 1%, 2%, 3%, 4%, 5%, 6%, 7%, 8%, 9%, 10%, 20%, 30%.

Through the third image generated by the processing assembly 30, the brightness of the transition region 60 along the vertical direction of the splicing direction is substantially the same or changes substantially linearly, reducing the brightness difference within the transition region 60. For example, the feature “the brightness of the transition region 60 being substantially the same” can mean that the brightness difference of each pixel within the transition region 60 is less than a preset brightness difference. The brightness of the transition region 60 changing substantially linearly can mean that the degree of difference between the change curve of the brightness values of each pixel in the filtering region along the vertical direction of the splicing direction and linear change is less than a preset degree of difference. When the third image is generated by splicing along the horizontal direction, the splicing direction is vertical, and the perpendicular direction of the splicing direction is horizontal.

In this implementation, the first image and the second image are captured by the first imaging assembly 10 and the second imaging assembly 20 of the imaging device, respectively, and the third image is generated by the processing assembly 30 of the imaging device based on the first image and the second image. This allows the brightness of the transition region 60 in the third image along the vertical direction of the splicing direction to be substantially the same or change substantially linearly. This reduces the brightness difference within the transition region 60 when generating the third image while ensuring independent exposure effects of each imaging assembly, resulting in a third image with good imaging quality, high dynamic range, and low brightness difference, thereby enhancing user experience.

It should be noted that the imaging device can include multiple imaging assemblies. When there are multiple imaging assemblies, any two imaging assemblies with overlapping view-finding regions can be used as the first imaging assembly 10 and the second imaging assembly 20 in the above implementation. When generating the third image, the images captured by each imaging assembly processed by the processing assembly 30 can be spliced, ensuring that the brightness of each transition region 60 is substantially the same or changes substantially linearly.

In some implementations, in the transition region 60, along the vertical direction of the splicing direction, the brightness difference between any two of the brightness of the overlapped region, the brightness of the first non-overlapped region 70, and the brightness of the second non-overlapped region 80 is less than the brightness difference threshold. The image content of the first non-overlapped region 70 is at least a part of the non-overlapped image content of the first image, the image content of the second non-overlapped region 80 is at least a part of the non-overlapped image content of the second image, and the image content of the overlapped region is at least a part of the overlapped image content between the first image and the second image.

As shown in FIG. 7, the transition region 60 not only includes the overlapping region A of the first image region 40 and the second image region 50 but also includes the non-overlapping part of the first image region 40 and the second image region 50. The non-overlapping part of the first image region 40 and the second image region 50 are the first non-overlapped region 70 and the second non-overlapped region 80, respectively, in the first image region 40 and the second image region 50. The image content of the first non-overlapped region 70 is at least a part of the non-overlapped image content of the first image, and the image content of the second non-overlapped region 80 is at least a part of the non-overlapped image content of the second image, i.e., the first non-overlapped region 70 and the second non-overlapped region 80 correspond to at least part of the non-overlapping view-finding regions of the first image and the second image, respectively.

In the transition region 60, along the vertical direction of the splicing direction, the brightness difference between any two of the brightness of the overlapped region A, the brightness of the first non-overlapped region 70, and the brightness of the second non-overlapped region 80 is less than the brightness difference threshold, ensuring that the brightness of the transition region 60 is substantially the same when the transition region 60 includes the overlapped region, the first non-overlapped region 70, and the second non-overlapped region 80. This ensures that the picture corresponding to the overlapping view-finding region and part of the non-overlapping view-finding region of the first image and the second image has substantially the same brightness in the third image.

In this implementation, the third image generated by the processing assembly 30 ensures that in the transition region 60, along the vertical direction of the splicing direction, the brightness difference between any two of the brightness of the overlapped region, the brightness of the first non-overlapped region 70, and the brightness of the second non-overlapped region 80 is less than the brightness difference threshold. When the transition region 60 includes the overlapping region of the first image region 40 and the second image region 50 and the non-overlapping part of the first image region 40 and the second image region 50, the brightness of the transition region 60 is substantially the same. This reduces the brightness difference within the transition region 60 when generating the third image while ensuring independent exposure effects of each imaging assembly, resulting in a third image with good imaging quality, high dynamic range, and low brightness difference, thereby enhancing user experience.

In some implementations, the processing assembly 30 is further configured to control the first imaging assembly 10 to capture the first image based on ambient brightness information corresponding to the view-finding region of the first imaging assembly 10, ensuring that the brightness of the first image region 40 in the generated third image is adapted to the ambient brightness of the view-finding region of the first imaging assembly 10. The processing assembly 30 is also configured to control the second imaging assembly 20 to capture the second image based on ambient brightness information corresponding to the view-finding region of the second imaging assembly 20, ensuring that the brightness of the second image region 50 in the generated third image is adapted to the ambient brightness of the view-finding region of the second imaging assembly 20.

When the first imaging assembly 10 captures the first image, the processing assembly 30 can control the first imaging assembly 10 to capture the first image based on the ambient brightness information corresponding to the view-finding region of the first imaging assembly 10, ensuring that the brightness of the first image is adapted to the ambient brightness information corresponding to the view-finding region of the first imaging assembly 10, i.e., ensuring the independent exposure effect of the first imaging assembly 10. In the subsequently generated third image, the brightness of the first image region 40 is adapted to the ambient brightness of the view-finding region of the first imaging assembly 10, ensuring that when generating the third image based on the first image and the second image, the brightness of the first image, i.e., the ambient brightness corresponding to the view-finding region of the first imaging assembly 10, is retained to a certain extent in the first image region 40, enhancing the brightness authenticity of the first image region 40.

When the second imaging assembly 20 captures the second image, the processing assembly 30 can control the second imaging assembly 20 to capture the second image based on the ambient brightness information corresponding to the view-finding region of the second imaging assembly 20, ensuring that the brightness of the second image is adapted to the ambient brightness information corresponding to the view-finding region of the second imaging assembly 20, i.e., ensuring the independent exposure effect of the second imaging assembly 20. In the subsequently generated third image, the brightness of the second image region 50 is adapted to the ambient brightness of the view-finding region of the second imaging assembly 20, ensuring that when generating the third image based on the first image and the second image, the brightness of the second image, i.e., the ambient brightness corresponding to the view-finding region of the second imaging assembly 20, is retained to a certain extent in the second image region 50, enhancing the brightness authenticity of the second image region 50.

In this implementation, the first imaging assembly 10 captures the first image, and the second imaging assembly 20 captures the second image using independent exposure strategies, with their exposure parameters determined based on their respective metering results.

In this implementation, the processing assembly 30 of the imaging device controls the first imaging assembly 10 and the second imaging assembly 20 to capture the first image and the second image based on the ambient brightness information corresponding to their respective view-finding regions, ensuring the independent exposure effects of the first imaging assembly 10 and the second imaging assembly 20, thereby enhancing the imaging effect of the third image. In the generated third image, the brightness of the first image region 40 and the brightness of the second image region 50 are adapted to the ambient brightness of the view-finding regions of the first imaging assembly 10 and the second imaging assembly 20, respectively. This ensures that the ambient brightness corresponding to the view-finding regions is retained to a certain extent in the first image region 40 and the second image region 50, enhancing the brightness authenticity of the first image region 40 and the second image region 50, thereby ensuring a high dynamic range and good imaging effect of the third image.

In some implementations, when capturing the first image and the second image, the first imaging assembly 10 and the second imaging assembly 20 use independent exposure strategies for exposure control.

When the first imaging assembly 10 and the second imaging assembly 20 capture the first image and the second image, respectively, they use independent exposure strategies for exposure control, ensuring that the first image and the second image captured by the first imaging assembly 10 and the second imaging assembly 20, respectively, have independent and good exposure effects, enhancing the imaging effect of the third image. For example, the first imaging assembly 10 and the second imaging assembly 20 can perform exposure control based on the ambient brightness information corresponding to their respective view-finding regions using different exposure parameters, such as exposure time, ensuring that the brightness of the first image and the second image is adapted to the ambient brightness corresponding to their respective view-finding regions.

In this implementation, the first imaging assembly 10 and the second imaging assembly 20 use independent exposure strategies for exposure control to capture the first image and the second image, ensuring that the image brightness of the first image and the second image is adapted to the ambient brightness corresponding to their respective view-finding regions, ensuring that the first image and the second image have independent and good exposure effects, thereby enhancing the imaging effect and dynamic range of the third image.

In some implementations, generating the third image based on the first image and the second image includes performing brightness adjustment processing on the first image and the second image, respectively, to obtain a fourth image corresponding to the first image and a fifth image corresponding to the second image. Image splicing processing is then performed on the fourth image and the fifth image to obtain the third image.

After capturing the first image and the second image through the first imaging assembly 10 and the second imaging assembly 20, respectively, the processing assembly 30 generates the third image based on the first image and the second image by first performing brightness adjustment processing on the first image and the second image, respectively, to obtain a fourth image and a fifth image corresponding to the first image and the second image, respectively. The image content of the first image is the same as that of the fourth image, but the image brightness is different. The image content of the second image is the same as that of the fifth image, but the image brightness is different, ensuring that the brightness of the fourth image and the fifth image in the region corresponding to the transition region 60 is substantially the same or changes substantially linearly.

Since the view-finding regions of the first imaging assembly 10 and the second imaging assembly 20 partially overlap, the fourth image and the fifth image also have some overlapping image content. After obtaining the fourth image and the fifth image that have undergone brightness adjustment processing, image splicing processing is performed on the fourth image and the fifth image, using the part with the same image content as the overlapped region of the third image, to splice the fourth image and the fifth image into the third image. The fourth image and the fifth image have undergone brightness adjustment processing, ensuring that the brightness of the transition region 60 of the spliced third image is substantially the same or changes substantially linearly.

In this implementation, by performing brightness adjustment processing on the first image and the second image, respectively, to obtain a fourth image corresponding to the first image and a fifth image corresponding to the second image, and performing image splicing processing on the fourth image and the fifth image, the generation of the third image is achieved. By performing brightness adjustment processing on the first image and the second image before splicing, the brightness of the fourth image and the fifth image in the region corresponding to the transition region 60 is substantially the same or changes substantially linearly, reducing the brightness difference within the transition region 60, ensuring that the third image has good imaging quality, high dynamic range, and low brightness difference, thereby enhancing user experience.

In some implementations, performing brightness adjustment processing on the first image and the second image, respectively, to obtain a fourth image corresponding to the first image and a fifth image corresponding to the second image includes determining the first gain adjustment information of the first image and second gain adjustment information of the second image based on first exposure parameters of the first image and second exposure parameters of the second image. The first exposure parameters are the exposure parameters when the first imaging assembly 10 captures the first image, and the second exposure parameters are the exposure parameters when the second imaging assembly 20 captures the second image. Based on the first gain adjustment information, brightness adjustment processing is performed on the first image to obtain the fourth image, and based on the second gain adjustment information, brightness adjustment processing is performed on the second image to obtain the fifth image.

When performing brightness adjustment processing on the first image and the second image through the processing assembly 30, the first gain adjustment information of the first image and the second gain adjustment information of the second image are first determined based on the first exposure parameters corresponding to the first image and the second exposure parameters corresponding to the second image. Since the first image and the second image are independently acquired by the first imaging assembly 10 and the second imaging assembly 20, respectively, and can adapt to the ambient brightness of the corresponding view-finding regions, there are differences between the first exposure parameters corresponding to the first image and the second exposure parameters corresponding to the second image. In some implementations, the number of first exposure parameters and second exposure parameters can be one or more, and both first exposure parameters and second exposure parameters can include exposure duration. The first gain adjustment information and the second gain adjustment information can be determined based on the difference in exposure duration between the first image and the second image.

Gain adjustment information can be used to adjust image signals, allowing for amplification and reduction of image brightness. After determining the first gain adjustment information and the second gain adjustment information, brightness adjustment processing can be performed on the first image and the second image, respectively, based on the first gain adjustment information and the second gain adjustment information, achieving the acquisition of the fourth image and the fifth image. This ensures that the image brightness of at least part of the fourth image and the fifth image corresponds to the differences in exposure parameters of the first image and the second image.

In this implementation, the first gain adjustment information of the first image and the second gain adjustment information of the second image are determined based on the first exposure parameters corresponding to the first image and the second exposure parameters corresponding to the second image. Brightness adjustment processing is then performed on the first image and the second image, respectively, based on the first gain adjustment information and the second gain adjustment information, achieving the acquisition of the fourth image and the fifth image. Using the first exposure parameters and the second exposure parameters as the basis for determining the first gain adjustment information and the second gain adjustment information ensures that the image brightness of the fourth image and the fifth image corresponds to the exposure differences of the first image and the second image, reducing the brightness difference within the transition region 60. This ensures that the third image has good imaging quality, high dynamic range, and low brightness difference, enhancing user experience.

In some implementations, determining the first gain adjustment information of the first image and the second gain adjustment information of the second image based on the first exposure parameters corresponding to the first image and the second exposure parameters corresponding to the second image includes: determining the first exposure difference information corresponding to the first image and the second exposure difference information corresponding to the second image based on the first exposure parameters and the second exposure parameters. The first gain adjustment information is determined based on the first exposure difference information, and the second gain adjustment information is determined based on the second exposure difference information.

When determining the first gain adjustment information of the first image and the second gain adjustment information of the second image based on the first exposure parameters corresponding to the first image and the second exposure parameters corresponding to the second image, the first exposure difference information corresponding to the first image and the second exposure difference information corresponding to the second image are first determined based on the first exposure parameters and the second exposure parameters. The first exposure difference information can represent the degree of exposure difference between the first image and the second image when the first image is the main subject, and the second exposure difference information can represent the degree of exposure difference between the second image and the first image when the second image is the main subject. These can determine the overall brightness difference between the first image and the second image to a certain extent.

After determining the first exposure difference information and the second exposure difference information, the first gain adjustment information and the second gain adjustment information are determined based on the first exposure difference information and the second exposure difference information, respectively. This ensures that the first gain adjustment information and the second gain adjustment information correspond to the degree of exposure difference between the first image and the second image, ensuring that the subsequent brightness adjustment processing can reduce the brightness difference in the transition region 60.

In this implementation, the first exposure difference information corresponding to the first image and the second exposure difference information corresponding to the second image are determined based on the first exposure parameters and the second exposure parameters. The first gain adjustment information and the second gain adjustment information are then determined based on the first exposure difference information and the second exposure difference information, respectively, achieving the determination of the first gain adjustment information and the second gain adjustment information, providing a basis for the brightness adjustment processing of the first image and the second image. Using the first exposure difference information and the second exposure difference information as the basis for determining the first gain adjustment information and the second gain adjustment information ensures that the first gain adjustment information and the second gain adjustment information correspond to the degree of exposure difference between the first image and the second image. This ensures that the brightness adjustment processing can reduce the brightness difference in the transition region 60, ensuring that the third image has good imaging quality, high dynamic range, and low brightness difference, enhancing user experience.

In some implementations, the first gain adjustment information includes a first gain table, the range of the first gain table corresponds to the first image, and the first gain table includes multiple first sub-regions, each first sub-region having a corresponding first gain value. The second gain adjustment information includes a second gain table, the range of the second gain table corresponds to the second image, and the second gain table includes multiple second sub-regions, each second sub-region having a corresponding second gain value.

The first gain adjustment information used as the basis for brightness adjustment processing of the first image can be a first gain table, the range of the first gain table corresponding to the first image, and the first gain table includes multiple first sub-regions. In some implementations, the range of the first image and the first gain table can be a rectangle of the same size, and the first gain table includes multiple first sub-regions of the same shape and size. The number of first sub-regions can be set according to the actual demand for brightness adjustment precision. Each first sub-region has a corresponding first gain value, which can be used to adjust the image signal of the first image. For example, when the first gain value of a first sub-region is 1, the brightness of the image area corresponding to the first sub-region in the first image remains unchanged after brightness adjustment processing. When the first gain value is greater than 1, the brightness of the image area corresponding to the first sub-region in the first image increases after brightness adjustment processing. The brightness of the corresponding image area in the first image can be adjusted through the first gain values of each first sub-region in the first gain table.

The second gain adjustment information used as the basis for brightness adjustment processing of the second image can be a second gain table, the range of which corresponds to the second image, and the second gain table includes multiple second sub-regions. In some implementations, the range of the second image and the second gain table can be a rectangle of the same size, and the second gain table includes multiple second sub-regions of the same shape and size. The number of second sub-regions can be set according to the actual demand for brightness adjustment precision. Each second sub-region has a corresponding second gain value, which can be used to adjust the image signal of the second image. For example, when the second gain value of a second sub-region is 1, the brightness of the image area corresponding to the second sub-region in the second image remains unchanged after brightness adjustment processing. When the second gain value is greater than 1, the brightness of the image area corresponding to the second sub-region in the second image increases after brightness adjustment processing. The brightness of the corresponding image area in the second image can be adjusted through the second gain values of each second sub-region in the second gain table.

In this implementation, the first gain table and the second gain table are used as the first gain adjustment information and the second gain adjustment information, respectively. The brightness of the corresponding image area in the first image can be adjusted based on the first gain values of each first sub-region in the first gain table, and the brightness of the corresponding image area in the second image can be adjusted based on the second gain values of each second sub-region in the second gain table. This achieves the brightness adjustment processing of the first image and the second image, reducing the brightness difference in the transition region 60, ensuring that the third image has good imaging quality, high dynamic range, and low brightness difference, enhancing user experience.

In some implementations, determining the first gain adjustment information based on the first exposure difference information includes: determining a first preset region 90 of the first image, the first preset region 90 corresponding to at least part of the first sub-regions, and the first preset region 90 corresponding to the first exposure difference information. The first gain values of each first sub-region corresponding to the first preset region 90 are determined based on the first exposure difference information to obtain the first gain table.

When determining the first gain adjustment information based on the first exposure difference information, the first preset region 90 of the first image is first determined. As shown in FIG. 8, the first preset region 90 can correspond to at least part of the first sub-regions in the first gain table, ensuring that the range of the first preset region 90 can correspond to at least part of the range of the first gain table. The first preset region 90 corresponds to the first exposure difference information, i.e., the range of the first preset region 90 can correspond to the degree of exposure difference between the first image and the second image. The first gain values of each first sub-region corresponding to the first preset region 90 are determined by the degree of exposure difference between the first image and the second image.

After determining the first preset region 90, the first gain values of each first sub-region corresponding to the first preset region 90 are determined based on the first exposure difference information to obtain the first gain table. In some implementations, when the first preset region 90 corresponds to all the first sub-regions, the first gain values of each first sub-region can be determined based on the first exposure difference information, ensuring that the first gain values of all the first sub-regions used for brightness adjustment processing correspond to the degree of exposure difference between the first image and the second image. When the first preset region 90 corresponds to part of the first sub-regions, the first gain values of each first sub-region corresponding to the first preset region 90 can be determined based on the first exposure difference information, ensuring that the first gain values of part of the first sub-regions used for brightness adjustment processing correspond to the degree of exposure difference between the first image and the second image, and the initial gain values of the remaining first sub-regions are used as the first gain values of that part of the first sub-regions.

In this implementation, by determining the first preset region 90 of the first image and determining the first gain values of each first sub-region corresponding to the first preset region 90 based on the first exposure difference information, the determination of the first gain table is achieved, providing a basis for the brightness adjustment processing of the first image. Using the first exposure difference information as the basis for determining the first gain values of each first sub-region corresponding to the first preset region 90 ensures that the first gain values of the first sub-regions in the first gain table that need to be used for brightness adjustment processing correspond to the degree of exposure difference between the first image and the second image. This ensures that the brightness adjustment processing of the first image through the first gain table can reduce the brightness difference in the transition region 60.

In some implementations, determining the second gain adjustment information based on the second exposure difference information includes: determining a second preset region 100 of the second image, the second preset region 100 corresponding to at least part of the second sub-regions, and the second preset region 100 corresponding to the second exposure difference information. The second gain values of each second sub-region corresponding to the second preset region 100 are determined based on the second exposure difference information to obtain the second gain table.

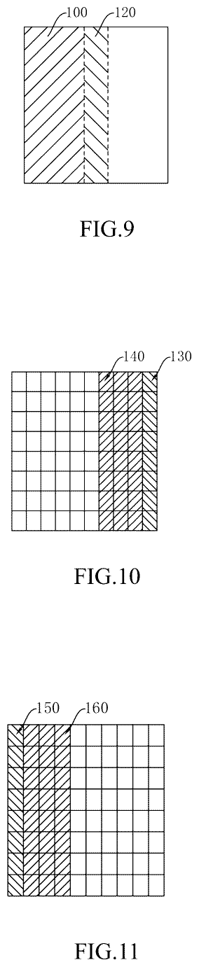

When determining the second gain adjustment information based on the second exposure difference information, the second preset region 100 of the second image is first determined. As shown in FIG. 9, the second preset region 100 can correspond to at least part of the second sub-regions in the second gain table, ensuring that the range of the second preset region 100 can correspond to at least part of the range of the second gain table. The second preset region 100 corresponds to the second exposure difference information, i.e., the range of the second preset region 100 can correspond to the degree of exposure difference between the second image and the first image. The second gain values of each second sub-region corresponding to the second preset region 100 are determined by the degree of exposure difference between the first image and the second image.

After determining the second preset region 100, the second gain values of each second sub-region corresponding to the second preset region 100 are determined based on the second exposure difference information to obtain the second gain table. In some implementations, when the second preset region 100 corresponds to all the second sub-regions, the second gain values of each second sub-region can be determined based on the second exposure difference information, ensuring that the second gain values of all the second sub-regions used for brightness adjustment processing correspond to the degree of exposure difference between the first image and the second image. When the second preset region 100 corresponds to part of the second sub-regions, the second gain values of each second sub-region corresponding to the second preset region 100 can be determined based on the second exposure difference information, ensuring that the second gain values of part of the second sub-regions used for brightness adjustment processing correspond to the degree of exposure difference between the first image and the second image, and the initial gain values of the remaining second sub-regions are used as the second gain values of that part of the second sub-regions.

In this implementation, by determining the second preset region 100 of the second image and determining the second gain values of each second sub-region corresponding to the second preset region 100 based on the second exposure difference information, the determination of the second gain table is achieved, providing a basis for the brightness adjustment processing of the second image. Using the second exposure difference information as the basis for determining the second gain values of each second sub-region corresponding to the second preset region 100 ensures that the second gain values of the second sub-regions in the second gain table that need to be used for brightness adjustment processing correspond to the degree of exposure difference between the first image and the second image. This ensures that the brightness adjustment processing of the second image through the second gain table can reduce the brightness difference in the transition region 60.

In some implementations, determining the first preset region 90 of the first image includes: performing region division on the first image based on the view-finding regions of the first image and the second image to obtain the first preset region 90.

Determining the second preset region 100 of the second image includes: performing region division on the second image based on the view-finding regions of the second image and the first image to obtain the second preset region 100.

When determining the first preset region 90 of the first image, region division can be performed on the first image based on the view-finding regions of the first image and the second image to obtain the first preset region 90 corresponding to the first exposure difference information and at least part of the first sub-regions. In some implementations, the overlapping view-finding region of the first image and the second image can be determined based on the view-finding regions of the first image and the second image. The first preset region 90 in the first image that actually needs brightness adjustment processing can be determined based on the ratio of the overlapping view-finding region to the entire view-finding region and the demand for reducing brightness difference, ensuring that the range of the first preset region 90 allows the brightness of the transition region 60 in the third image to be substantially the same or change substantially linearly.

When determining the second preset region 100 of the second image, region division can be performed on the second image based on the view-finding regions of the first image and the second image to obtain the second preset region 100 corresponding to the second exposure difference information and at least part of the second sub-regions. In some implementations, the overlapping view-finding region of the first image and the second image can be determined based on the view-finding regions of the first image and the second image. The second preset region 100 in the second image that actually needs brightness adjustment processing can be determined based on the ratio of the overlapping view-finding region to the entire view-finding region and the demand for reducing brightness difference, ensuring that the range of the second preset region 100 allows the brightness of the transition region 60 in the third image to be substantially the same or change substantially linearly.

In this implementation, region division is performed on the first image and the second image based on their view-finding regions, obtaining the first preset region 90 and the second preset region 100, achieving the determination of the first preset region 90 and the second preset region 100, providing a basis for obtaining the first gain table and the second gain table. Using the view-finding regions of the first image and the second image as the basis for region division ensures that the first preset region 90 and the second preset region 100 are the regions in the first image and the second image that actually need brightness adjustment processing, ensuring that the range of the first preset region 90 and the second preset region 100 allows the brightness of the transition region 60 in the third image to be substantially the same or change substantially linearly, reducing the brightness difference in the transition region 60, ensuring that the third image has good imaging quality, high dynamic range, and low brightness difference, enhancing user experience.

In some implementations, the intersection of the first preset region 90 and the second preset region 100 in the third image corresponds to the transition region 60.

As mentioned earlier, the first preset region 90 is the region in the first image corresponding to at least part of the first sub-regions in the first gain table, and the second preset region 100 is the region in the second image corresponding to at least part of the second sub-regions in the second gain table. The brightness of the first image can be adjusted based on the first gain values of each first sub-region corresponding to the first preset region 90, and the brightness of the second image can be adjusted based on the second gain values of each second sub-region corresponding to the second preset region 100, ensuring that the first preset region 90 of the first image and the second preset region 100 of the second image can be used as regions for brightness adjustment processing, respectively.

Therefore, the ranges of the first preset region 90 and the second preset region 100 can be set such that their intersection in the third image corresponds to the transition region 60. This ensures that the image content of the transition region 60 corresponds to the image content of the first preset region 90 and the second preset region 100 in the first image and the second image, respectively. Moreover, the brightness of the transition region 60 is adjusted to reduce brightness differences after brightness adjustment processing of the first preset region 90 and the second preset region 100, allowing the brightness of the transition region 60 to be substantially the same or change substantially linearly.

In this implementation, by setting the ranges of the first preset region 90 and the second preset region 100, their intersection in the third image corresponds to the transition region 60. When the first preset region 90 of the first image and the second preset region 100 of the second image can respectively serve as regions for brightness adjustment processing, it ensures that the brightness of the transition region 60 corresponds to the brightness after reducing brightness differences following brightness adjustment processing of the first preset region 90 and the second preset region 100. This reduces the brightness difference in the transition region 60, ensuring that the third image has good imaging quality, high dynamic range, and low brightness difference, enhancing user experience.

In some implementations, the first image further includes a third preset region 110, located at the center of the first image. Each first sub-region corresponding to the third preset region 110 has a corresponding first preset gain value. The second image further includes a fourth preset region 120, located at the center of the second image, and each second sub-region corresponding to the fourth preset region 120 has a corresponding second preset gain value.

As shown in FIG. 8, the first image further includes a third preset region 110, located at the center of the first image, and each first sub-region corresponding to the third preset region 110 has a corresponding first preset gain value. When determining the first gain value of each first sub-region, the first preset gain value of each first sub-region within the third preset region 110 can be directly used as the first gain value of that part of the first sub-region. This ensures that the initial brightness of the third preset region 110 at the center position of the first image is maintained during brightness adjustment processing, and brightness adjustment processing is only performed on the first preset region 90 of the first image. This reduces the brightness difference in the transition region 60 while maintaining the initial brightness of the center position of the first image.

As shown in FIG. 9, the second image further includes a fourth preset region 120, located at the center of the second image, and each second sub-region corresponding to the fourth preset region 120 has a corresponding second preset gain value. When determining the second gain value of each second sub-region, the second preset gain value of each second sub-region within the fourth preset region 120 can be directly used as the second gain value of that part of the second sub-region. This ensures that the initial brightness of the fourth preset region 120 at the center position of the second image is maintained during brightness adjustment processing, and brightness adjustment processing is only performed on the second preset region 100 of the second image. This reduces the brightness difference in the transition region 60 while maintaining the initial brightness of the center position of the second image.

In this implementation, by setting the third preset region 110 in the first image and ensuring that each first sub-region corresponding to the third preset region 110 has a corresponding first preset gain value, and setting the fourth preset region 120 in the second image and ensuring that each second sub-region corresponding to the fourth preset region 120 has a corresponding second preset gain value, the first preset gain value of each first sub-region within the third preset region 110 can be directly used as the first gain value of that part of the first sub-region, and the second preset gain value of each second sub-region within the fourth preset region 120 can be directly used as the second gain value of that part of the second sub-region. During brightness adjustment processing, the initial brightness of the center position of both the first image and the second image can be maintained, and brightness adjustment processing is performed on the first preset region 90 and the second preset region 100, respectively. This reduces the brightness difference in the transition region 60 of the third image while maintaining the initial brightness of the center positions of the first image and the second image.

In some implementations, determining the first gain value of each first sub-region corresponding to the first preset region 90 based on the first exposure difference information includes: determining a part of the first sub-regions corresponding to the first preset region 90 as the first target sub-region 130 and determining another part of the first sub-regions corresponding to the first preset region 90 as the second target sub-region 140, where the first target sub-region 130 is set farther from the third preset region 110 compared to the second target sub-region 140. The gain value of each first target sub-region 130 is determined based on the first exposure difference information. The gain value of each second target sub-region 140 is determined based on the gain values of the first target sub-regions 130, the first preset gain value, and the positions of the second target sub-regions 140.

When determining the first gain value of each first sub-region corresponding to the first preset region 90 based on the first exposure difference information, the two parts of the first sub-regions in the first gain table that the first preset region 90 corresponds to are first determined as the first target sub-region 130 and the second target sub-region 140, respectively. As shown in FIG. 10, the first target sub-region 130 is set farther from the third preset region 110, i.e., the center position of the first image, compared to the second target sub-region 140. The first target sub-region 130 may be located at the splicing edge of the brightness-adjusted first image and second image.

After determining the first target sub-region 130 and the second target sub-region 140, the gain value of each first target sub-region 130 can be determined based on the first exposure difference information. The gain value of each second target sub-region 140 is determined based on the gain values of the first target sub-regions 130, the first preset gain value, and the positions of the second target sub-regions 140. In some implementations, the gain value of the first target sub-region 130 can be determined based on the first exposure difference information. Using the relative positional relationship of each second target sub-region 140 and the first target sub-region 130 with the corresponding third preset region 110 in the first image, the gain values of the first target sub-region 130 and the first preset gain value are used as the starting and ending values to conduct interpolation calculation on the gain value of each second target sub-region 140. Finally, the first gain value of each first sub-region corresponding to the first preset region 90, including the first target sub-region 130 and the second target sub-region 140, is obtained.

In this implementation, by determining that the first preset region 90 in the first gain table corresponds to two parts of the first sub-regions, namely the first target sub-region 130 and the second target sub-region 140, and determining the gain value of each first target sub-region 130 based on the first exposure difference information, then determining the gain value of each second target sub-region 140 based on the gain values of the first target sub-regions 130, the first preset gain value, and the positions of the second target sub-regions 140, the first gain value of each first sub-region corresponding to the first preset region 90, including the first target sub-region 130 and the second target sub-region 140, is obtained. Using the gain values of each first target sub-region 130, the first preset gain value, and the positions of each second target sub-region 140 as the basis for determining the gain value of each second target sub-region 140, the gain value of the second target sub-region 140 can be determined through interpolation calculation based on the gain value of the first target sub-region 130 determined by the degree of brightness difference at the edge position, improving the accuracy of determining the first gain value, thereby enhancing the precision of brightness adjustment for the first image.

In some implementations, determining the second gain value of each second sub-region corresponding to the second preset region 100 based on the second exposure difference information includes: determining a part of the second sub-regions corresponding to the second preset region 100 as the third target sub-region 150 and determining another part of the second sub-regions corresponding to the second preset region 100 as the fourth target sub-region 160, where the third target sub-region 150 is set farther from the fourth preset region 120 compared to the fourth target sub-region 160. The gain value of each third target sub-region 150 is determined based on the second exposure difference information. The gain value of each fourth target sub-region 160 is determined based on the gain values of the third target sub-regions 150, the second preset gain value, and the positions of the fourth target sub-regions 160.

When determining the second gain value of each second sub-region corresponding to the second preset region 100 based on the second exposure difference information, the two parts of the first sub-regions in the second gain table that the second preset region 100 corresponds to are first determined as the third target sub-region 150 and the fourth target sub-region 160, respectively. As shown in FIG. 11, the third target sub-region 150 is set farther from the fourth preset region 120, i.e., the center position of the second image, compared to the fourth target sub-region 160. In some implementations, the third target sub-region 150 may be located at the splicing edge of the brightness-adjusted first image and second image.

After determining the third target sub-region 150 and the fourth target sub-region 160, the gain value of each third target sub-region 150 can be determined based on the second exposure difference information. The gain value of each fourth target sub-region 160 is determined based on the gain values of the third target sub-regions 150, the second preset gain value, and the positions of the fourth target sub-regions 160. In some implementations, the gain value of the third target sub-region 150 can be determined based on the second exposure difference information. Using the relative positional relationship of each fourth target sub-region 160 and the third target sub-region 150 with the corresponding fourth preset region 120 in the second image, the gain values of the third target sub-region 150 and the second preset gain value are used as the starting and ending values to conduct interpolation calculation on the gain value of each fourth target sub-region 160. Finally, the second gain value of each second sub-region corresponding to the second preset region 100, including the third target sub-region 150 and the fourth target sub-region 160, is obtained.

In this implementation, by determining that the second preset region 100 in the second gain table corresponds to two parts of the second sub-regions, namely the third target sub-region 150 and the fourth target sub-region 160, and determining the gain value of each third target sub-region 150 based on the second exposure difference information, then determining the gain value of each fourth target sub-region 160 based on the gain values of the third target sub-regions 150, the second preset gain value, and the positions of the fourth target sub-regions 160, the second gain value of each second sub-region corresponding to the second preset region 100, including the third target sub-region 150 and the fourth target sub-region 160, is obtained. Using the gain values of each third target sub-region 150, the second preset gain value, and the positions of each fourth target sub-region 160 as the basis for determining the gain value of each fourth target sub-region 160, the gain value of the fourth target sub-region 160 can be determined through interpolation calculation based on the gain value of the third target sub-region 150 determined by the degree of brightness difference at the edge position, improving the accuracy of determining the second gain value, thereby enhancing the precision of brightness adjustment for the second image.

In some implementations, determining the first gain value of each first sub-region corresponding to the first preset region 90 based on the first exposure difference information includes: determining the first brightness difference information corresponding to the first exposure difference information based on the first exposure difference information. The first ratio value corresponding to the first brightness difference information is determined based on the first brightness difference information. The first gain value of each first sub-region is determined based on the first ratio value.

Determining the second gain value of each second sub-region corresponding to the second preset region 100 based on the second exposure difference information includes: determining the second brightness difference information corresponding to the second exposure difference information based on the second exposure difference information. The second ratio value corresponding to the second brightness difference information is determined based on the second brightness difference information. The second gain value of each second sub-region is determined based on the second ratio value.

When determining the first gain value of each first sub-region corresponding to the first preset region 90 based on the first exposure difference information, the first brightness difference information corresponding to the first exposure difference information is first determined based on the first exposure difference information, converting the exposure difference between the first imaging assembly 10 and the second imaging assembly 20 into the image brightness difference of the first image and the second image generated by the exposure difference. The first ratio value corresponding to the first brightness difference information is determined based on the first brightness difference information, converting the image brightness difference of the first image and the second image into a dimensionless ratio value of 1. In some implementations, the brightness difference value represented by the first brightness difference information can be divided by a preset value to obtain the first ratio value. The first gain value of each first sub-region is then determined based on the first ratio value, providing a basis for determining the first gain table. In some implementations, the gain value of each first target sub-region 130 can be determined based on the first ratio value, and the gain value of each second target sub-region 140 is determined based on the gain values of the first target sub-regions 130, the first preset gain value, and the positions of the second target sub-regions 140.

When determining the second gain value of each second sub-region corresponding to the second preset region 100 based on the second exposure difference information, the second brightness difference information corresponding to the second exposure difference information is first determined based on the second exposure difference information, converting the exposure difference between the first imaging assembly 10 and the second imaging assembly 20 into the image brightness difference of the first image and the second image generated by the exposure difference. The second ratio value corresponding to the second brightness difference information is determined based on the second brightness difference information, converting the image brightness difference of the first image and the second image into a dimensionless ratio value of 1. In some implementations, the brightness difference value represented by the second brightness difference information can be divided by a preset value to obtain the second ratio value. The second gain value of each second sub-region is then determined based on the second ratio value, providing a basis for determining the second gain table. In some implementations, the gain value of each third target sub-region 150 can be determined based on the second ratio value, and the gain value of each fourth target sub-region 160 is determined based on the gain values of the third target sub-regions 150, the second preset gain value, and the positions of the fourth target sub-regions 160.

In this implementation, based on the first exposure difference information, the first brightness difference information corresponding to the first exposure difference information is determined. Based on the first brightness difference information, the first ratio value corresponding to the first brightness difference information is determined. Then, based on the first ratio value, the first gain value of each first sub-region is determined, providing a basis for determining the first gain table. Based on the second exposure difference information, the second brightness difference information corresponding to the second exposure difference information is determined. Based on the second brightness difference information, the second ratio value corresponding to the second brightness difference information is determined. Then, based on the second ratio value, the second gain value of each second sub-region is determined, providing a basis for determining the second gain table. The first gain value of each first sub-region and the second gain value of each second sub-region can respectively adapt to the degree of exposure difference of the first exposure difference information and the second exposure difference information, i.e., the first image and the second image, reducing the brightness difference after brightness adjustment processing of the first preset region 90 and the second preset region 100. This ensures that the third image has good imaging quality, high dynamic range, and low brightness difference, enhancing user experience.

In other implementations, determining the first gain value of each first sub-region corresponding to the first preset region 90 based on the first exposure difference information includes: determining the first brightness difference information corresponding to the first exposure difference information based on the first exposure difference information. Based on the first brightness difference information, the first gain value of each first sub-region is determined.

Determining the second gain value of each second sub-region corresponding to the second preset region 100 based on the second exposure difference information includes: determining the second brightness difference information corresponding to the second exposure difference information based on the second exposure difference information. Based on the second brightness difference information, the second gain value of each second sub-region is determined.

When determining the first gain value of each first sub-region corresponding to the first preset region 90 based on the first exposure difference information, the first brightness difference information corresponding to the first exposure difference information is first determined based on the first exposure difference information, converting the exposure difference between the first imaging assembly 10 and the second imaging assembly 20 into the image brightness difference of the first image and the second image generated by the exposure difference. The first gain value of each first sub-region is directly determined based on the first brightness difference information. In some implementations, the gain value of each first target sub-region 130 can be determined based on the first brightness difference information, and the gain value of each second target sub-region 140 is determined based on the gain values of the first target sub-regions 130, the first preset gain value, and the positions of the second target sub-regions 140.

When determining the second gain value of each second sub-region corresponding to the second preset region 100 based on the second exposure difference information, the second brightness difference information corresponding to the second exposure difference information is first determined based on the second exposure difference information, converting the exposure difference between the first imaging assembly 10 and the second imaging assembly 20 into the image brightness difference of the first image and the second image generated by the exposure difference. The second gain value of each second sub-region is directly determined based on the second brightness difference information. In some implementations, the gain value of each third target sub-region 150 can be determined based on the second brightness difference information, and the gain value of each fourth target sub-region 160 is determined based on the gain values of the third target sub-regions 150, the second preset gain value, and the positions of the fourth target sub-regions 160.

In this implementation, based on the first exposure difference information, the first brightness difference information corresponding to the first exposure difference information is determined, and based on the first brightness difference information, the first gain value of each first sub-region is determined, providing a basis for determining the first gain table. Based on the second exposure difference information, the second brightness difference information corresponding to the second exposure difference information is determined, and based on the second brightness difference information, the second gain value of each second sub-region is determined, providing a basis for determining the second gain table. The first gain value of each first sub-region and the second gain value of each second sub-region can respectively adapt to the degree of exposure difference of the first exposure difference information and the second exposure difference information, i.e., the first image and the second image, reducing the brightness difference after brightness adjustment processing of the first preset region 90 and the second preset region 100. This ensures that the third image has good imaging quality, high dynamic range, and low brightness difference, enhancing user experience.

In some implementations, determining the first brightness difference information corresponding to the first exposure difference information based on the first exposure difference information includes: determining the first brightness difference information corresponding to the first exposure difference information based on the first exposure difference information and the first preset configuration information, where the first preset configuration information is used to characterize the correspondence relationship between the exposure difference information and the brightness difference information.

Determining the second brightness difference information corresponding to the second exposure difference information based on the second exposure difference information includes: determining the second brightness difference information corresponding to the second exposure difference information based on the second exposure difference information and the first preset configuration information.

The first preset configuration information can characterize the correspondence relationship between the exposure difference information and the brightness difference information. In some implementations, the first preset configuration information can be a data set including multiple data groups, each data group including exposure difference information and the brightness difference information corresponding to the exposure difference information. The first preset configuration information can also be a mapping relationship curve, which can characterize the brightness difference information corresponding to continuous exposure difference information.

When determining the first brightness difference information corresponding to the first exposure difference information based on the first exposure difference information, the first brightness difference information corresponding to the first exposure difference information can be determined based on the first exposure difference information and the first preset configuration information, achieving the determination of the first brightness difference information. When determining the second brightness difference information corresponding to the second exposure difference information based on the second exposure difference information, the second brightness difference information corresponding to the second exposure difference information can be determined based on the second exposure difference information and the first preset configuration information, achieving the determination of the second brightness difference information.

In this implementation, using the first preset configuration information that can characterize the correspondence relationship between the exposure difference information and the brightness difference information as a basis, the conversion from the first exposure difference information to the first brightness difference information and from the second exposure difference information to the second brightness difference information can be achieved, realizing the determination of the first brightness difference information and the second brightness difference information. This provides a basis for the subsequent determination of the first ratio value and the second ratio value or the first gain table and the second gain table, ensuring the accuracy of the first brightness difference information and the second brightness difference information, thereby enhancing the accuracy of the brightness adjustment processing, ensuring that the third image has good imaging quality and low brightness difference.

In some implementations, determining the first ratio value corresponding to the first brightness difference information based on the first brightness difference information includes: determining the first ratio value corresponding to the first brightness difference information based on the first brightness difference information and the second preset configuration information, where the second preset configuration information is used to characterize the correspondence relationship between the brightness difference information and the ratio value.

Determining the second ratio value corresponding to the second brightness difference information based on the second brightness difference information includes: determining the second ratio value corresponding to the second brightness difference information based on the second brightness difference information and the second preset configuration information.

The second preset configuration information can characterize the correspondence relationship between the brightness difference information and the ratio value. In some implementations, the second preset configuration information can be a data set including multiple data groups, each data group including brightness difference information and the ratio value corresponding to the brightness difference information. The second preset configuration information can also be a mapping relationship curve, which can characterize the ratio value corresponding to continuous brightness difference information.

When determining the first ratio value corresponding to the first brightness difference information based on the first brightness difference information, the first ratio value corresponding to the first brightness difference information can be determined based on the first brightness difference information and the second preset configuration information, achieving the determination of the first ratio value. When determining the second ratio value corresponding to the second brightness difference information based on the second brightness difference information, the second ratio value corresponding to the second brightness difference information can be determined based on the second brightness difference information and the second preset configuration information, achieving the determination of the second ratio value.

In this implementation, using the second preset configuration information that can characterize the correspondence relationship between the brightness difference information and the ratio value as a basis, the conversion from the first brightness difference information to the first ratio value and from the second brightness difference information to the second ratio value can be achieved, realizing the determination of the first ratio value and the second ratio value. This provides a basis for the subsequent determination of the first gain table and the second gain table, ensuring the accuracy of the first ratio value and the second ratio value, thereby enhancing the accuracy of the brightness adjustment processing, ensuring that the third image has good imaging quality and low brightness difference.

In some implementations, performing brightness adjustment processing on the first image based on the first gain adjustment information to obtain the fourth image includes: multiplying the pixel value of each pixel of the first image by the first gain value of each pixel corresponding to the first sub-region in the first gain table, to obtain the first target pixel value of each pixel, thereby obtaining the fourth image.

Performing brightness adjustment processing on the second image based on the second gain adjustment information to obtain the fifth image includes: multiplying the pixel value of each pixel of the second image by the second gain value of each pixel corresponding to the second sub-region in the second gain table, to obtain the second target pixel value of each pixel, thereby obtaining the fifth image.

When performing brightness adjustment processing on the first image based on the first gain adjustment information, the pixel value of each pixel of the first image can be multiplied by the first gain value of each pixel corresponding to the first sub-region in the first gain table, and the result of the multiplication is used as the first target pixel value of each pixel, thereby obtaining the fourth image with the adjusted pixel values. The pixel values of the first image can be adjusted through the first gain values in the first gain table to achieve brightness adjustment processing of the first image. In some implementations, if it is necessary to increase the image brightness of a part of the image area of the first image to reduce the brightness difference in the transition region 60, the pixel value of each pixel in that part of the image area can be multiplied by a first gain value greater than 1, so that the pixel value of each pixel in the same image area in the fourth image is amplified to the first target pixel value.

When performing brightness adjustment processing on the second image based on the second gain adjustment information, the pixel value of each pixel of the second image can be multiplied by the second gain value of each pixel corresponding to the second sub-region in the second gain table, and the result of the multiplication is used as the second target pixel value of each pixel, thereby obtaining the fifth image with the adjusted pixel values. The pixel values of the second image can be adjusted through the second gain values in the second gain table to achieve brightness adjustment processing of the second image. In some implementations, if it is necessary to decrease the image brightness of a part of the image area of the second image to reduce the brightness difference in the transition region 60, the pixel value of each pixel in that part of the image area can be multiplied by a second gain value less than 1, so that the pixel value of each pixel in the same image area in the fifth image is reduced to the second target pixel value.

In this implementation, the pixel value of each pixel of the first image is multiplied by the first gain value of each pixel corresponding to the first sub-region in the first gain table, as the first target pixel value of each pixel, to obtain the fourth image. The pixel value of each pixel of the second image is multiplied by the second gain value of each pixel corresponding to the second sub-region in the second gain table, as the second target pixel value of each pixel, to obtain the fifth image. This achieves the brightness adjustment processing of the first image and the second image. This ensures that the first target pixel value of the pixels in the fourth image and the second target pixel value of the pixels in the fifth image are substantially the same or change substantially linearly within the corresponding transition region 60 of the third image, reducing the brightness difference in the transition region 60, ensuring that the third image has good imaging quality, high dynamic range, and low brightness difference, enhancing user experience.

In some implementations, the processing assembly 30 is also configured to perform video synthesis on the plurality of third images within a preset time to obtain a target video.

Within the preset time, the first imaging assembly 10 and the second imaging assembly 20 can capture multiple first images and second images, respectively. The processing assembly 30 can generate the third image corresponding to that time based on the first image and the second image at the same time, and perform video synthesis on the plurality of third images within the preset time to obtain the target video corresponding to that preset time.

It can be understood that since each third image is a spliced image, the third image can achieve the effect of a panoramic image through image splicing, and each third image has good imaging quality, high dynamic range, and low brightness difference. Therefore, the target video obtained by video synthesis of multiple third images can also have the effect of a panoramic image, good imaging quality, high dynamic range, and low brightness difference.

In this implementation, by performing video synthesis on the plurality of third images within a preset time, the target video is obtained. The synthesis of the third images with a panoramic effect results in a target video with a panoramic effect, ensuring that the target video also has good imaging quality, high dynamic range, and low brightness difference, enhancing the user experience of video shooting.

In some implementations, the processing assembly 30 includes an image signal processing unit, which is used to perform brightness adjustment processing on the first image based on the first gain adjustment information to obtain the fourth image and perform brightness adjustment processing on the second image based on the second gain adjustment information to obtain the fifth image.

The processing assembly 30 can include an image signal processing unit (ISP). When generating the third image based on the first image and the second image through the processing assembly 30, the image signal processing unit of the processing assembly 30 can perform brightness adjustment processing on the first image based on the first gain adjustment information to obtain the fourth image, and perform brightness adjustment processing on the second image based on the second gain adjustment information to obtain the fifth image, i.e., the image signal processing unit executes the brightness adjustment processing of the first image and the second image to obtain the fourth image and the fifth image used for splicing the third image.

In this implementation, the image signal processing unit of the processing assembly 30 performs brightness adjustment processing on the first image based on the first gain adjustment information to obtain the fourth image, and performs brightness adjustment processing on the second image based on the second gain adjustment information to obtain the fifth image, achieving the brightness adjustment processing of the first image and the second image, providing a basis for generating the third image. Using the image signal processing unit to execute the brightness adjustment processing of the first image and the second image can fully utilize the performance of the image signal processing unit, reducing the overall performance occupation of the imaging device, decreasing the response time for generating the third image, and enhancing user experience.

In some implementations, the processing assembly 30 includes a shooting control unit, which is used to determine the first gain adjustment information of the first image and the second gain adjustment information of the second image based on the first exposure parameters corresponding to the first image and the second exposure parameters corresponding to the second image. The shooting control unit is also used to perform image splicing processing on the fourth image and the fifth image to obtain the third image.

The processing assembly 30 also includes a shooting control unit, which can be, for example, the central processing unit (CPU) of the imaging device. When generating the third image based on the first image and the second image through the processing assembly 30, the shooting control unit of the processing assembly 30 can determine the first gain adjustment information of the first image and the second gain adjustment information of the second image based on the first exposure parameters corresponding to the first image and the second exposure parameters corresponding to the second image, providing a basis for the brightness adjustment processing of the first image and the second image. The shooting control unit of the processing assembly 30 can also perform image splicing processing on the fourth image and the fifth image to obtain the third image, achieving the generation of the third image.

In some implementations, when generating the third image based on the first image and the second image through the processing assembly 30, the shooting control unit of the processing assembly 30 can determine the first gain adjustment information of the first image and the second gain adjustment information of the second image based on the first exposure parameters corresponding to the first image and the second exposure parameters corresponding to the second image. The image signal processing unit of the processing assembly 30 performs brightness adjustment processing on the first image based on the first gain adjustment information to obtain the fourth image and performs brightness adjustment processing on the second image based on the second gain adjustment information to obtain the fifth image. Then, the shooting control unit of the processing assembly 30 performs image splicing processing on the fourth image and the fifth image to obtain the third image.

In this implementation, the shooting control unit of the processing assembly 30 determines the first gain adjustment information of the first image and the second gain adjustment information of the second image based on the first exposure parameters corresponding to the first image and the second exposure parameters corresponding to the second image, providing a basis for the brightness adjustment processing of the first image and the second image. The shooting control unit of the processing assembly 30 performs image splicing processing on the fourth image and the fifth image to obtain the third image, achieving the generation of the third image. By executing different steps of generating the third image through the image signal processing unit and the shooting control unit of the processing assembly 30, the performance of the image signal processing unit and the shooting control unit is fully utilized, reducing the overall performance occupation of the imaging device, decreasing the response time for generating the third image, and enhancing user experience.

In some implementations, the imaging device further includes a housing, where the image sensor of the first imaging assembly 10, the image sensor of the second imaging assembly 20, and the processing assembly 30 are all disposed inside the housing.

Those skilled in the art will readily think of other implementations of the present disclosure after considering the specification and practicing the present disclosure disclosed herein. The present disclosure is intended to cover any variations, uses, or adaptations of the present disclosure, following the general principles of the present disclosure and including known or conventional techniques in the field not disclosed in the present disclosure. The specification and examples are to be considered as exemplary only, and the true scope and spirit of the present disclosure are indicated by the following claims.

It should be understood that the present disclosure is not limited to the precise structure already described and illustrated in the drawings, and various modifications and changes can be made without departing from the scope thereof. The scope of the present disclosure is limited only by the claims appended.

What is claimed is:

1. An imaging device, comprising:
a first imaging assembly, configured to capture a first image;
a second imaging assembly, configured to capture a second image, wherein part of a view-finding region of the first imaging assembly overlaps with part of a view-finding region of the second imaging assembly; and
a processing assembly, connected with the first imaging assembly and the second imaging assembly, and configured to generate a third image based on the first image and the second image,
wherein the third image is a spliced image, and the third image comprises a transition region from a first image region to a second image region;
wherein a brightness of the transition region is substantially the same or changes substantially linearly; and
wherein image content of the first image region comprises at least part of image content of the first image, and image content of the second image region comprises at least part of image content of the second image.

2. The imaging device according to claim 1, wherein in the transition region, along a vertical direction of a splicing direction, a difference between any two of a brightness of an overlapped region, a brightness of a first non-overlapped region, and a brightness of a second non-overlapped region is less than a brightness difference threshold;
image content of the first non-overlapped region comprises at least part of non-overlapped image content of the first image;
image content of the second non-overlapped region comprises at least part of non-overlapped image content of the second image; and
image content of the overlapped region comprises at least part of overlapped image content between the first image and the second image.

3. The imaging device according to claim 1, wherein the processing assembly is further configured to:
control the first imaging assembly to capture the first image based on ambient brightness information corresponding to the view-finding region of the first imaging assembly, wherein, in the third image, a brightness of the first image region in the third image is adapted to ambient brightness of the view-finding region of the first imaging assembly; and
control the second imaging assembly to capture the second image based on ambient brightness information corresponding to the view-finding region of the second imaging assembly, and wherein, in the third image, a brightness of the second image region in the third image is adapted to ambient brightness of the view-finding region of the second imaging assembly.

4. The imaging device according to claim 1, wherein when capturing the first image and the second image, the first imaging assembly and the second imaging assembly are configured to apply independent exposure strategies for exposure control, respectively.

5. The imaging device according to claim 1, wherein the processing assembly is further configured to generate the third image based on the first image and the second image at least by:
performing brightness adjustment processing on the first image and the second image, respectively, to obtain a fourth image corresponding to the first image and a fifth image corresponding to the second image; and
performing image splicing processing on the fourth image and the fifth image, respectively, to obtain the third image.

6. The imaging device according to claim 5, wherein the processing assembly is further configured to perform the brightness adjustment processing on the first image and the second image, respectively, to obtain the fourth image corresponding to the first image and the fifth image corresponding to the second image at least by:
determining first gain adjustment information of the first image and second gain adjustment information of the second image based on first exposure parameters of the first image and second exposure parameters of the second image, respectively, wherein the first exposure parameters are exposure parameters when the first imaging assembly captures the first image, and the second exposure parameters are exposure parameters when the second imaging assembly captures the second image; and
performing brightness adjustment processing on the first image based on the first gain adjustment information to obtain the fourth image, and performing brightness adjustment processing on the second image based on the second gain adjustment information to obtain the fifth image.

7. The imaging device according to claim 6, wherein the processing assembly is further configured to determine the first gain adjustment information of the first image and the second gain adjustment information of the second image based on the first exposure parameters of the first image and the second exposure parameters of the second image, respectively, at least by:
determining first exposure difference information of the first image and second exposure difference information of the second image based on the first exposure parameters and the second exposure parameters, respectively; and
determining the first gain adjustment information based on the first exposure difference information, and the second gain adjustment information based on the second exposure difference information.

8. The imaging device according to claim 7, wherein:
the first gain adjustment information comprises a first gain table, a range of the first gain table corresponds to the first image, the first gain table comprises a plurality of first sub-regions, and each first sub-region has a corresponding first gain value; and
the second gain adjustment information comprises a second gain table, a range of the second gain table corresponds to the second image, the second gain table comprises a plurality of second sub-regions, and each second sub-region has a corresponding second gain value.

9. The imaging device according to claim 8, wherein:
the processing assembly is further configured to determine the first gain adjustment information based on the first exposure difference information at least by:
determining a first preset region of the first image, the first preset region corresponding to at least part of the plurality of first sub-regions, and the first preset region corresponding to the first exposure difference information; and
determining first gain values of each of the plurality of first sub-regions corresponding to the first preset region based on the first exposure difference information, to obtain the first gain table; and
the processing assembly is further configured to determine the second gain adjustment information based on the second exposure difference information at least by:
determining a second preset region of the second image, the second preset region corresponding to at least part of the plurality of second sub-regions, and the second preset region corresponding to the second exposure difference information; and
determining second gain values of each of the plurality of second sub-regions corresponding to the second preset region based on the second exposure difference information, to obtain the second gain table.

10. The imaging device according to claim 9, wherein:
the processing assembly is further configured to determine the first preset region of the first image at least by:
performing region division on the first image based on a view-finding region of the first image and a view-finding region of the second image to obtain the first preset region; and
the processing assembly is further configured to determine the second preset region of the second image at least by:
performing region division on the second image based on the view-finding region of the second image and the view-finding region of the first image to obtain the second preset region.

11. The imaging device according to claim 9, wherein an intersection of the first preset region and the second preset region in the third image corresponds to the transition region.

12. The imaging device according to claim 9, wherein:
the first image further comprises a third preset region, the third preset region is located at a central position of the first image, and each of the plurality of first sub-regions corresponding to the third preset region has a corresponding first preset gain value; and
the second image further comprises a fourth preset region, the fourth preset region is located at a central position of the second image, and each of the plurality of second sub-regions corresponding to the fourth preset region has a corresponding second preset gain value.

13. The imaging device according to claim 12, wherein the processing assembly is further configured to:
determine the first gain values of each of the plurality of first sub-regions corresponding to the first preset region based on the first exposure difference information at least by:
determining part of the plurality of first sub-regions corresponding to the first preset region as a first target sub-region, and determining part of the plurality of first sub-regions corresponding to the first preset region as a second target sub-region, wherein the first preset region corresponding to the first target sub-region is farther from the third preset region than the first preset region corresponding to the second target sub-region;
determining gain values of the first target sub-regions based on the first exposure difference information; and
determining gain values of the second target sub-regions based on the gain values of the first target sub-regions, the first preset gain values, and positions of the second target sub-regions; and
determine the second gain values of each of the plurality of second sub-regions corresponding to the second preset region based on the second exposure difference information at least by:
determining part of the plurality of second sub-regions corresponding to the second preset region as a third target sub-region, and determining part of the plurality of second sub-regions corresponding to the second preset region as a fourth target sub-region, wherein the second preset region corresponding to the third target sub-region is farther from the fourth preset region than the second preset region corresponding to the fourth target sub-region;
determining gain values of the third target sub-regions based on the second exposure difference information; and
determining gain values of the fourth target sub-regions based on the gain values of the third target sub-regions, the second preset gain values, and positions of the fourth target sub-regions.

14. The imaging device according to claim 9, wherein the processing assembly is further configured to perform at least one of a first operation or a second operation,
wherein the first operation comprises:
determining the first gain values of each of the plurality of first sub-regions corresponding to the first preset region based on the first exposure difference information at least by:
determining first brightness difference information corresponding to the first exposure difference information based on the first exposure difference information;
determining a first ratio value corresponding to the first brightness difference information based on the first brightness difference information; and
determining the first gain values of each of the plurality of first sub-regions based on the first ratio value; and
determining the second gain values of each of the plurality of second sub-regions corresponding to the second preset region based on the second exposure difference information at least by:
determining second brightness difference information corresponding to the second exposure difference information based on the second exposure difference information;
determining a second ratio value corresponding to the second brightness difference information based on the second brightness difference information; and
determining the second gain values of each of the plurality of second sub-regions based on the second ratio value; and
wherein the second operation comprises:
determining the first gain values of each of the plurality of first sub-regions corresponding to the first preset region based on the first exposure difference information at least by:
determining the first brightness difference information corresponding to the first exposure difference information based on the first exposure difference information; and
determining the first gain values of each of the plurality of first sub-regions based on the first brightness difference information; and
determining the second gain values of each of the plurality of second sub-regions corresponding to the second preset region based on the second exposure difference information at least by:
determining the second brightness difference information corresponding to the second exposure difference information based on the second exposure difference information; and
determining the second gain values of each of the plurality of second sub-regions based on the second brightness difference information.

15. The imaging device according to claim 14, wherein the processing assembly is further configured to at least one of a third operation or a fourth operation,
wherein the third operation comprises:
determining the first brightness difference information corresponding to the first exposure difference information based on the first exposure difference information at least by determining the first brightness difference information corresponding to the first exposure difference information based on the first exposure difference information and first preset configuration information, wherein the first preset configuration information is used to indicate a correspondence relationship between exposure difference information and brightness difference information; and
determining the second brightness difference information corresponding to the second exposure difference information based on the second exposure difference information at least by determining the second brightness difference information corresponding to the second exposure difference information based on the second exposure difference information and the first preset configuration information; and
wherein the fourth operation comprises:
determining the first ratio value corresponding to the first brightness difference information based on the first brightness difference information at least by determining the first ratio value corresponding to the first brightness difference information based on the first brightness difference information and second preset configuration information, wherein the second preset configuration information is used to indicate a correspondence relationship between brightness difference information and ratio values; and
determining the second ratio value corresponding to the second brightness difference information based on the second brightness difference information at least by determining the second ratio value corresponding to the second brightness difference information based on the second brightness difference information and the second preset configuration information.

16. The imaging device according to claim 8, wherein the processing assembly is further configured to:
perform the brightness adjustment processing on the first image based on the first gain adjustment information to obtain the fourth image at least by multiplying a pixel value of each pixel of the first image by the first gain value of each pixel corresponding to the first sub-region in the first gain table to obtain a first target pixel value of each pixel to obtain the fourth image; and
perform the brightness adjustment processing on the second image based on the second gain adjustment information to obtain the fifth image at least by multiplying a pixel value of each pixel of the second image by the second gain value of each pixel corresponding to the second sub-region in the second gain table to obtain a second target pixel value of each pixel to obtain the fifth image.

17. The imaging device according to claim 1, wherein the processing assembly is further configured to:
perform video synthesis on a plurality of third images within a preset time to obtain a target video.

18. The imaging device according to claim 6, wherein the processing assembly comprises an image signal processing unit, and the image signal processing unit is configured to:
perform brightness adjustment processing on the first image based on the first gain adjustment information to obtain the fourth image, and
perform brightness adjustment processing on the second image based on the second gain adjustment information to obtain the fifth image.

19. The imaging device according to claim 6, wherein the processing assembly comprises a shooting control unit, and the shooting control unit is configured to perform at least one of:
determining the first gain adjustment information of the first image and the second gain adjustment information of the second image based on the first exposure parameters of the first image and the second exposure parameters of the second image; or
performing image splicing processing on the fourth image and the fifth image to obtain the third image.

20. The imaging device according to claim 1, further comprising a housing, wherein an image sensor of the first imaging assembly, an image sensor of the second imaging assembly, and the processing assembly are disposed inside the housing.
